(19) United States
(12) Patent Application Publication
(10) Pub. No.: US 2026/0330998 A1
(43) Pub. Date: Oct. 22, 2026

(54) INFORMATION OUTPUT DEVICE

(71) Applicant: DOT INCORPORATION, Seoul (KR)

(72) Inventors: Ju Yoon KIM, Gimpo-si (KR); Ji Ho KIM, Gimpo-si (KR); Hyeon Cheol PARK, Gwangmyeong-si (KR)

(21) Appl. No.: 19/118,006

(22) PCT Filed: Aug. 21, 2023
(86) PCT No.: PCT/KR2023/012315

§ 371 Date: Apr. 3, 2025

(30) Foreign Application Priority Data
Aug. 24, 2022 (KR) 10-2022-0106113

(51) Int. Cl. G09B 21/00

(52) U.S. Cl. CPC G09B 21/004

(57) ABSTRACT

According to embodiments of the present disclosure, there is provided an information output device including one or more information output units, wherein each of the one or more information output units includes a driving source part connected to a power supply and disposed to allow a current to flow, an expression part formed and disposed to be detected by a user, a base part in which the driving source part and the expression part are accommodated, a first driving part disposed in the base part and driven by the current flowing in the driving source part, and a second driving part disposed between the first driving part and the expression part, rotatably disposed in the base part, configured to perform an angular movement or a rotational movement in response to the driving of the first driving part to transmit a driving force to the expression part.

### TECHNICAL FIELD

Embodiments of the present disclosure relate to an information output device.

### BACKGROUND ART

Users may perceive information in various ways. To this end, various types of information output devices are being used. For example, visual information output devices using printed materials and audio information output devices using sound are being used.

In particular, in modern times, as an amount of information increases and technology develops, information output devices including electronic technology are being widely used, and display devices including a plurality of pixels are being commonly used as visual information output devices.

However, in the case of such display devices, various circuits or the like are embedded, which reduces convenience in manufacturing and causes inconvenience in control.

Meanwhile, due to the development of technologies, the diversification of lifestyles, and the like, various information output types are required.

For example, various information output devices may be required according to the situation of each user, and in particular, users with weakened specific senses, such as those with weak visual capacity or without visual capacity, require information output through the sense of touch. When information is output through the sense of touch, it is difficult to easily control and stably drive the output, and thus there is a limitation in improving user convenience through improvements in information output devices.

### DISCLOSURE OF INVENTION

### Technical Problem

Embodiments of the present disclosure have been devised to improve the above limitations and are directed to providing an information output device with improved durability and enhanced user convenience.

However, these problems are exemplary, and the scope of the present disclosure is not limited thereby.

### Solution to Problem

According to an embodiment of the present disclosure, there is provided an information output device comprising one or more information output units, wherein each of the one or more information output units includes a driving source part connected to a power supply and disposed to allow a current to flow, an expression part formed and disposed to be detected by a user, a base part in which the driving source part and the expression part are accommodated, a first driving part disposed in the base part and driven by the current flowing in the driving source part, and a second driving part disposed between the first driving part and the expression part, rotatably disposed in the base part, configured to perform an angular movement or a rotational movement in response to the driving of the first driving part to transmit a driving force to the expression part.

In the present disclosure, the base part may include a first accommodating part in which the driving source part is accommodated, a second accommodating part which is disposed to face the first accommodating part and in which the expression part is accommodated, and a third accommodating part which connects the first accommodating part to the second accommodating part and in which the second driving part is disposed.

In the present disclosure, the first driving part may include a first magnetic force part and may be disposed inside the driving source part.

In the present disclosure, the first driving part may share a longitudinal central axis with the driving source part.

In the present disclosure, the information output device may include a plurality of information output units, wherein the plurality of information output units may be disposed to be spaced apart from each other in one direction or another direction different from the one direction.

Other aspects, features, and advantages other than those described above will become apparent from the following drawings, claims and detailed description of the invention.

### Advantageous Effects of Invention

An information output device according to the present disclosure has an effect of improving durability and improving user convenience.

### BRIEF DESCRIPTION OF DRAWINGS

FIG. 1 is a perspective view illustrating an information output unit according to an embodiment of the present disclosure.

FIG. 2 is an exploded perspective view illustrating a plurality of information output units according to an embodiment of the present disclosure.

FIG. 3 is a perspective view illustrating a second driving part according to an embodiment of the present disclosure.

FIGS. 4 to 7 are views illustrating states in which the information output unit is driven according to an embodiment of the present disclosure.

FIG. 8 is a perspective view illustrating an information output device according to an embodiment of the present disclosure.

### BEST MODE FOR CARRYING OUT THE INVENTION

While the present disclosure is susceptible to various modifications and alternative forms, specific embodiments thereof are shown by way of example in the drawings and will herein be described in detail. Advantages and features of the present disclosure and methods for accomplishing the same will be more clearly understood from embodiments described below with reference to the drawings. However, the present disclosure is not limited to the embodiments disclosed below but may be implemented in various forms.

Hereinafter, the embodiments of the present disclosure will be described below in detail with reference to the accompanying drawings, but when describing with reference to the drawings, equal or corresponding components will be referred to as the same reference numerals, and redundant descriptions thereof will be omitted.

In the following embodiments, the terms “first,” “second,” and the like have been used to distinguish one component from another, rather than limitative in all aspects.

In the following embodiments, singular forms are intended to include plural forms as well, unless the context clearly indicates otherwise.

It will be further understood that the terms “including” and/or “having” used herein specify the presence of stated features or components, but do not preclude the presence or addition of one or more other features or components.

In the following embodiments, when a part such as a film, a region, or a component is said to be “above” or “on” another part, not only a case in which the part is directly above another part, but also a case in which other films, regions, components, or the like are interposed therebetween are included.

Sizes of components in the drawings may be exaggerated or reduced for convenience of description. For example, the size and thickness of each component shown in the drawings are arbitrarily represented for convenience of description, and thus, the present disclosure is not necessarily limited thereto.

When a certain embodiment may be implemented differently, a specific process order may be performed differently from the described order. For example, two consecutively described processes may be performed substantially at the same time or performed in an order opposite to the described order.

In the following embodiments, when it is stated that films, regions, components, or the like are connected to each other, the films, regions, and components may not only be directly connected to each other but may also be indirectly connected to another film, region, and component interposed therebetween. For example, in the present specification, when it is stated that films, regions, components, or the like are electrically connected, the films, regions, components, or the like may not only be directly connected electrically to each other but may also be indirectly connected to each other electrically with another film, region, component, or the like interposed therebetween.

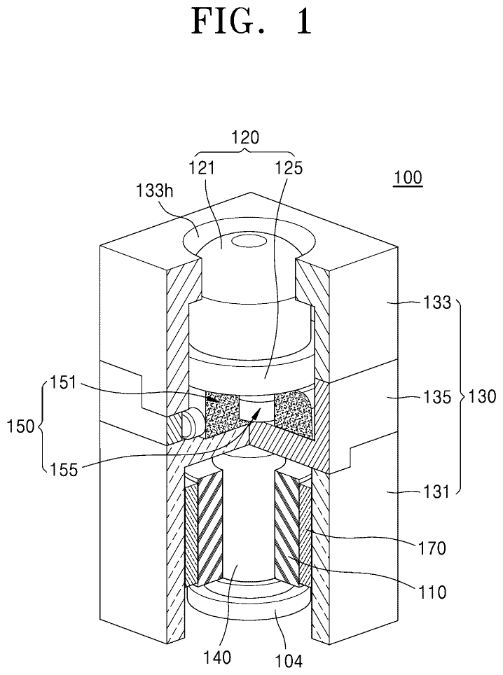

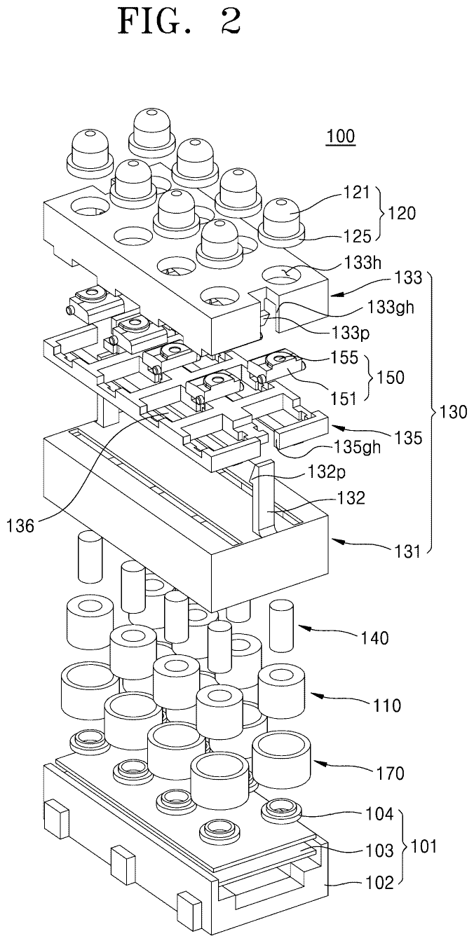

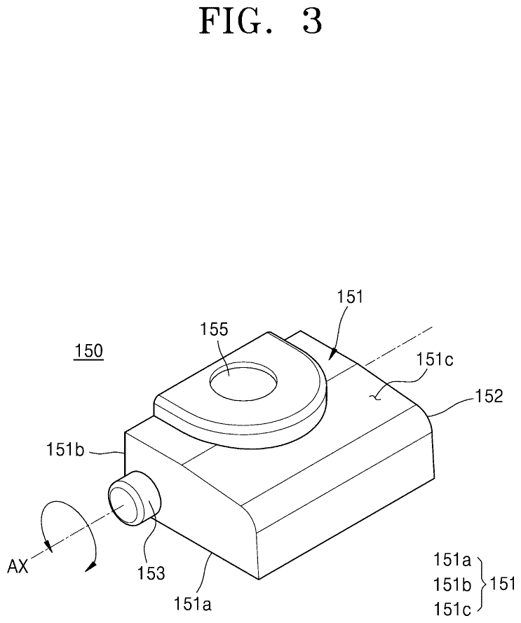

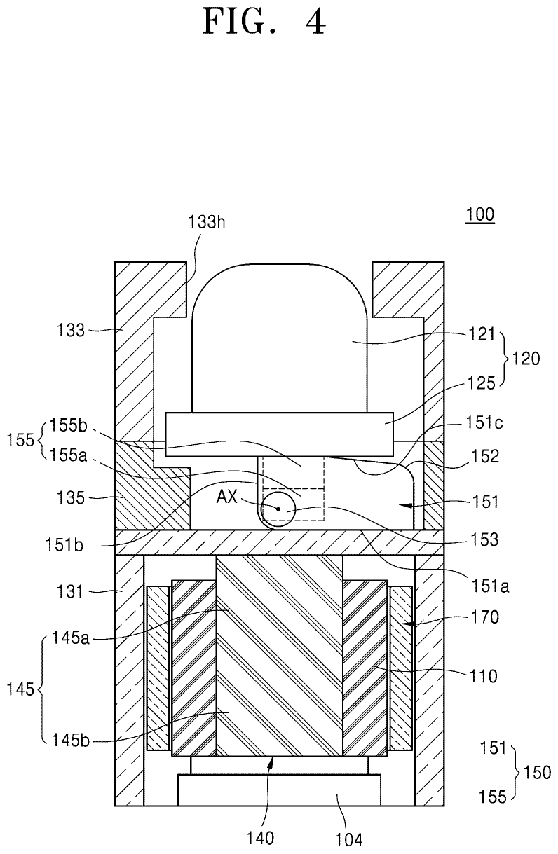

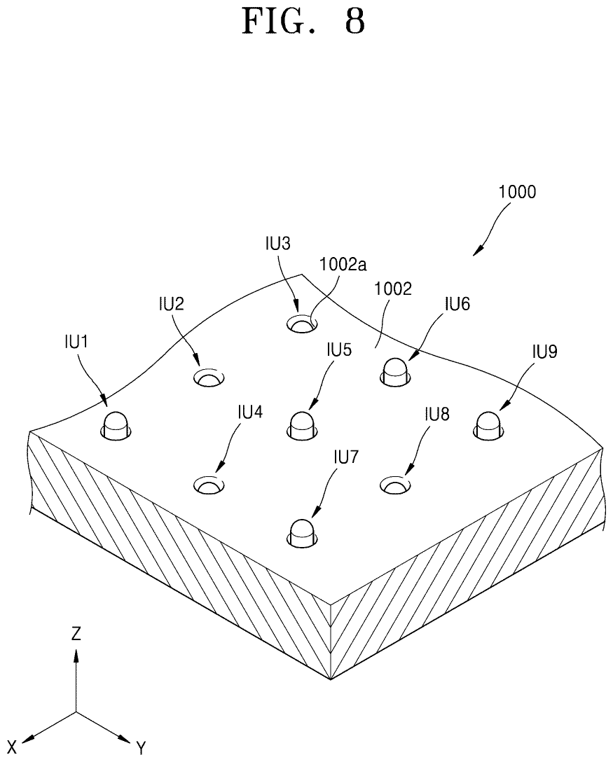

FIG. 1 is a perspective view illustrating an information output unit according to an embodiment of the present disclosure. FIG. 2 is an exploded perspective view illustrating a plurality of information output units according to an embodiment of the present disclosure. FIG. 3 is a perspective view illustrating a second driving part according to an embodiment of the present disclosure. FIGS. 4 to 7 are views illustrating states in which the information output unit is driven according to an embodiment of the present disclosure. FIG. 8 is a perspective view illustrating an information output device according to an embodiment of the present disclosure.

Referring to FIG. 8, an information output device 1000 according to an embodiment of the present disclosure may include a housing 1002 in which a plurality of via holes 1002a are formed, and a plurality of information output units IU1, IU2, IU3, IU4, IU5, IU6, IU7, IU8, and IU9 may be installed to correspond to the plurality of via holes 1002a.

Referring to FIG. 8, the information output device 1000 according to an embodiment of the present disclosure includes one or more information output units, and FIG. 1 illustrates one information output unit.

Referring to FIG. 2, FIG. 2 partially illustrates the information output device in which the plurality of information output units are disposed, and the plurality of information output units may be connected to each other to form a group.

Referring to FIG. 1, one information output unit is illustrated, but in an optional embodiment, the information output device may include two or more information output units as shown in FIGS. 2 and 8.

That is, depending on the application, characteristics of the applied product, and user characteristics, the information output device 1000 may include various numbers of information output units IU1, IU2, IU3, IU4, IU5, IU6, IU7, IU8, and IU9.

Referring to FIGS. 1, 2, and 8, the information output device according to an embodiment of the present disclosure includes at least one information output unit, and FIG. 1 illustrates one information output unit. That is, the information output device of FIG. 1 may be one information output unit.

FIGS. 1 and 4 to 7 are views taking a single information output unit as a reference, and hereinafter, for convenience of description, one information output unit 100 (hereinafter referred to as “information output device 100”) as shown in FIG. 1 will be described.

Referring to FIGS. 1 and 2 to 4, the information output device 100 according to an embodiment of the present disclosure may include a substrate part 101, a driving source part 110, an expression part 120, a base part 130, a first driving part 140, a second driving part 150, and a shielding part 170.

Referring to FIG. 2, the substrate part 101 according to an embodiment of the present disclosure may be electrically connected to a power supply and may include a substrate housing 102, a circuit part 103, and a contact plate 104.

Referring to FIG. 2, the substrate housing 102 may be connected to the base part 130 to be described below, and the base part 130 may be disposed on the substrate housing 102. The circuit part 103 may be disposed on the substrate housing 102 and may be formed as a printed circuit board (PCB).

Referring to FIGS. 1, 2, and 4, the contact plate 104 according to an embodiment of the present disclosure may be disposed on the circuit part 103 and may be disposed between the circuit part 103 and the driving source part 110 to be described below.

The contact plate 104 may be formed of a conductive material and may transmit a current transmitted from the circuit part 103 to the driving source part 110. The contact plate 104 may be disposed in a state of being in contact with each of the driving source part 110 and the circuit part 103.

Referring to FIGS. 1, 2, and 4 to 7, the driving source part 110 according to an embodiment of the present disclosure may be connected to the substrate part 101 and disposed to allow a current to flow, and may be formed of a coil.

Since the driving source part 110 according to an embodiment of the present disclosure is formed of a coil, a magnetic field may be formed around the driving source part 110 when a current flows.

The driving source part 110 may have various forms, may have a form in which a plurality of circuit wires are wound, and may be formed by varying the number of times of winding.

Referring to FIGS. 1, 2, and 4 to 7, the driving source part 110 according to an embodiment of the present disclosure may be formed in a cylindrical shape having open opposite sides, but this is for convenience of description, and as described above, in a state in which a plurality of circuit wires are wound, the driving source part 110 may have a shape disposed outside the first driving part 140 to be described below.

A magnetic field generated by the current flowing through the driving source part 110 according to an embodiment of the present disclosure may drive the first driving part 140 to be described below, and the driving of the first driving part 140 may cause the second driving part 150 to perform angular movement or rotational movement.

In addition, as the first driving part 140 and the second driving part 150 are driven, the resulting movement may provide a driving force to the expression part 120, which is in direct or indirect contact with the first driving part 140 and the second driving part 150.

Referring to FIGS. 1, 2, and 4 to 7, the first driving part 140 to be described below may be disposed inside the driving source part 110 according to an embodiment of the present disclosure, and the driving source part 110 and the first driving part 140 may share a longitudinal central axis (a vertical direction based on FIG. 1).

Referring to FIGS. 1, 2, and 4 to 7, the driving source part 110 according to an embodiment of the present disclosure may be disposed between the first driving part 140 and the shielding part 170 to be described below in a radial direction with respect to a longitudinal central axis.

Since the driving source part 110 is disposed inside the shielding part 170, power generated from the outside is transmitted to the driving source part 110 through the substrate part 101, and even when a magnetic field is formed in the driving source part 110, the magnetic field may not affect the driving source part 110 and the first driving part 140 provided in another information output device 100 positioned close to one information output device 100.

That is, when a plurality of information output devices 100 are driven, the plurality of information output devices 100 do not interfere with each other's operation, thereby allowing each information output device 100 to be driven independently.

In addition, since the shielding part 170 blocks a magnetic field, which is generated from the driving source part 110 disposed inside the shielding part 170, from being transmitted to the outside so that the plurality of information output devices 100 disposed close to each other may be independently and precisely driven.

Referring to FIGS. 1, 2, and 4 to 7, the expression part 120 according to an embodiment of the present disclosure may be formed and disposed to be detected by a user and may be moved in a preset direction according to the driving of the first driving part 140 and the second driving part 150, which are to be described below.

The expression part 120 according to an embodiment of the present disclosure may move upward or downward in position (based on FIG. 1) along a longitudinal central axis thereof.

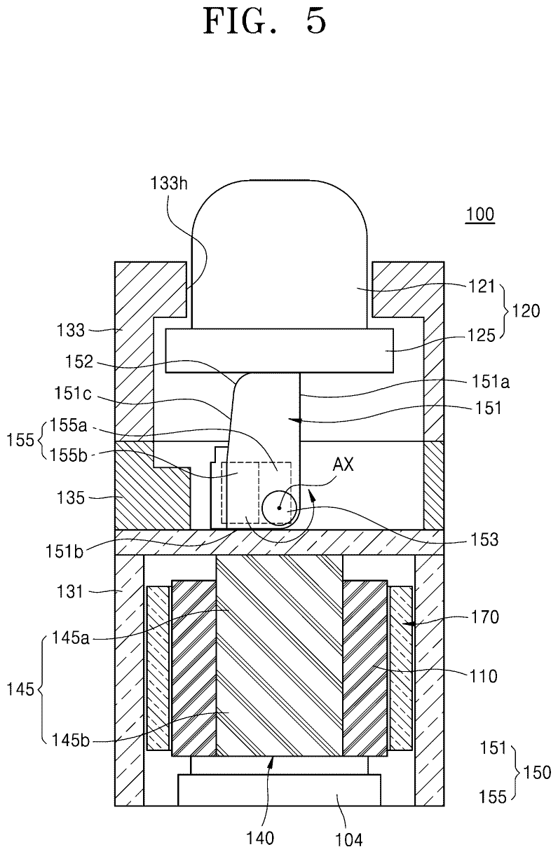

Referring to FIGS. 1, 2, and 4 to 7, the expression part 120 according to an embodiment of the present disclosure may move in a first direction (from the lower side to the upper side based on FIG. 4) to move toward the driving source part 110 or may move in a direction (from the upper side to the lower side based on FIG. 5) opposite to the first direction to move away from the driving source part 110.

Referring to FIGS. 1, 2, and 4, the expression part 120 according to an embodiment of the present disclosure may be exposed to the outside through the base part 130 to be described below, specifically, an inlet hole 133h formed in a second accommodating part 133.

Since the expression part 120 is exposed to the outside, a user may tactilely or visually detect the movement of the expression part 120 using a finger.

Referring to FIGS. 1, 2, and 4, the expression part 120 according to an embodiment of the present disclosure may include an expression surface 121 and a circumferential surface 125.

Referring to FIGS. 1, 2, and 4, the expression surface 121 may be a region that is relatively far away from the driving source part 110 among regions of the expression part 120 and may include a region recognized by a user.

In an optional embodiment, a user may recognize the expression part 120 through the entire region of the expression part 120, but may recognize only the expression surface 121.

For example, the user may detect the movement of the expression part 120 through contact with the expression surface 121, and the user may easily detect the movement of the expression part 120 through visual detection of the expression surface 121.

Referring to FIGS. 1 and 2, the expression surface 121 according to an embodiment of the present disclosure may be formed to be convex toward the outside and may include a curved surface. However, the present disclosure is not limited thereto, and the expression surface 121 may include a region having a cylindrical shape, in an optional embodiment, a region having a shape that is similar to a cylindrical shape.

Referring to FIG. 1, various modifications may be implemented in such a manner that an upper surface (based on FIG. 4) of the expression surface 121 according to an embodiment of the present disclosure may be formed to be flat and only corners formed in a radial direction with respect to the upper surface of the expression surface 121 may be formed to have a certain radius of curvature.

Referring to FIG. 1, the circumferential surface 125 may be a surface facing the second driving part 150 among regions of the expression part 120, may constitute a lower region of the expression part 120, and may be in contact with the second driving part 150.

The second driving part 150 may transmit a force to the expression part 120 through the circumferential surface 125. Specifically, in a state in which a second driving body 151 is in contact with a lower surface (based on FIG. 4) of the circumferential surface 125, the circumferential surface 125 may be moved in the first direction (from the lower side to the upper side based on FIG. 5), and the expression surface 121 may be exposed to the outside so that a user may recognize the expression part 120.

Referring to FIG. 4, the circumferential surface 125 according to an embodiment of the present disclosure may be connected to the expression surface 121 and may be formed to have the relatively longest length in a radial direction from the longitudinal central axis of the expression part 120.

Referring to FIGS. 2 and 4, the circumferential surface 125 according to an embodiment of the present disclosure may be formed in a disk shape, but the present disclosure is not limited thereto, and various modifications may be implemented without departing from the technical spirit in such a manner that the circumferential surface 125 may be formed in a quadrangular shape having an area that is relatively larger than an area of the inlet hole 133h formed in the base part 130, specifically, the second accommodating part 133.

In an optional embodiment, the circumferential surface 125 may be formed in a triangular shape without departing from the technical spirit such that a distance from a center of the circumferential surface 125 to an outer circumferential surface is relatively longer than a distance from a center of the inlet hole 133h formed in the second accommodating part 133 to an inner circumferential surface.

Since the area of the circumferential surface 125 according to an embodiment of the present disclosure is relatively larger than the area of the inlet hole 133h formed in the second accommodating part 133, when the expression part 120 receives a driving force from the second driving part 150 to move in a direction away from the driving source part 110, the circumferential surface 125 may be prevented from passing through the inlet hole 133h to be separated to the outside.

The expression part 120 according to an embodiment of the present disclosure may be formed of various materials and may be formed of an insulating material as a light and durable material. Specifically, the expression part 120 may contain a resin-based organic material and may include an inorganic material such as a ceramic material.

However, the present disclosure is not limited thereto, and various modifications may be implemented in such a manner that the expression part 120 may be formed of a material such as metal or glass.

Referring to FIGS. 1, 2, and 4 to 7, the base part 130 according to an embodiment of the present disclosure accommodates the driving source part 110, the first driving part 140, the second driving part 150, and the expression part 120 and may include a first accommodating part 131, the second accommodating part 133, and a third accommodating part 135.

The base part 130 according to an embodiment of the present disclosure may have a shape elongated to accommodate the driving source part 110, the first driving part 140, the second driving part 150, and the expression part 120 and may be formed to entirely surround all of the driving source part 110, the first driving part 140, the second driving part 150, and the expression part 120.

Referring to FIGS. 1, 2, and 4 to 7, the first accommodating part 131 according to an embodiment of the present disclosure accommodates the driving source part 110, the first driving part 140, and the shielding part 170, one side (upper side based on FIG. 2) thereof may be coupled to the third accommodating part 135, and another side (lower side based on FIG. 2) opposite to the one side may be coupled to the substrate part 101, specifically, the substrate housing 102.

Referring to FIG. 2, a hole (not denoted by reference numeral) may be formed in an upper surface (based on FIG. 2) of the first accommodating part 131 according to an embodiment of the present disclosure, and the first driving part 140 and the second driving part 150 may be disposed to face each other through the hole.

Referring to FIG. 2, a guide part 132 may be formed to extend upward from the upper surface (based on FIG. 2) of the first accommodating part 131 according to an embodiment of the present disclosure.

The guide part 132 may pass through a third accommodating guide groove 135gh formed in the third accommodating part 135 and a second accommodating guide groove 133gh formed in the second accommodating part 133, and thus the first accommodating part 131, the second accommodating part 133, and the third accommodating part 135 may be aligned and stably coupled in a height direction (the vertical direction based on FIG. 2).

Referring to FIG. 2, at an outer end portion of the guide part 132 according to an embodiment of the present disclosure, a hook part 132p may be formed to protrude at a certain angle with respect to a longitudinal direction (the vertical direction based on FIG. 2) of the guide part 132.

Since the hook part 132p is formed to protrude, the hook part 132p may be coupled to a guide protrusion 133p formed in the second accommodating part 133 in a hanging manner, and a fastening force between the first accommodating part 131, the second accommodating part 133, and the third accommodating part 135 may be further improved.

Referring to FIGS. 1, 2, and 4 to 7, the second accommodating part 133 according to an embodiment of the present disclosure may be disposed to face the first accommodating part 131 and may accommodate the expression part 120, and the inlet hole 133h may be formed in an upper surface (based on FIG. 2) thereof such that the expression part 120, specifically, the expression surface 121, protrudes therefrom and is exposed to the outside.

The first accommodating part 131 and the second accommodating part 133 according to an embodiment of the present disclosure may be disposed adjacent to each other and may be disposed not to overlap each other.

Referring to FIGS. 1, 2, and 4, the third accommodating part 135 may be disposed between the first accommodating part 131 and the second accommodating part 133 according to an embodiment of the present disclosure, and the second driving part 150 may be disposed in the third accommodating part 135 to perform angular movement or rotational movement.

Referring to FIG. 2, at one side of the second accommodating part 133 according to an embodiment of the present disclosure, the second accommodating guide groove 133gh, into which the guide part 132 formed in the first accommodating part 131 may be inserted, may be formed in a groove shape.

When the second accommodating part 133 moves toward the first accommodating part 131 so as to be coupled to the first accommodating part 131, the guide part 132 formed in the first accommodating part 131 may be inserted along the second accommodating guide groove 133gh formed in the second accommodating part 133.

Accordingly, the second accommodating part 133 may be moved toward the first accommodating part 131 along a preset coupling path and may be coupled to the third accommodating part 135 disposed in the first accommodating part 131.

Referring to FIG. 2, the guide protrusion 133p may be formed to protrude outward from the inside of the second accommodating guide groove 133gh formed in the second accommodating part 133 according to an embodiment of the present disclosure.

Since the guide protrusion 133p is formed to protrude outward from the inside of the second accommodating guide groove 133gh, the hook part 132p formed on the guide part 132 may be hung on and coupled to the guide protrusion 133p.

In addition, due to a hanging coupling between the guide protrusion 133p and the hook part 132p, an uncoupling between the first accommodating part 131 and the second accommodating part 133 can be prevented after the first accommodating part 131 and the second accommodating part 133 are coupled with the third accommodating part 135 interposed therebetween.

Referring to FIG. 2, the guide part 132 formed in the first accommodating part 131, the second accommodating guide groove 133gh formed in the second accommodating part 133, the guide protrusion 133p, and the third accommodating guide groove 135gh formed in the third accommodating part 135 according to an embodiment of the present disclosure are formed at one side of the base part 130, but the present disclosure is not limited thereto, and a pair of guide parts 132, a pair of second accommodating guide grooves 133gh, a pair of guide protrusions 133p, and a pair of third accommodating guide grooves 135gh may be provided and disposed to face each other.

As a result, it is possible to improve a fastening force between the first accommodating part 131, the second accommodating part 133, and the third accommodating part 135.

Referring to FIGS. 1, 2, and 4, the third accommodating part 135 according to an embodiment of the present disclosure may connect the first accommodating part 131 to the second accommodating part 133, and the second driving part 150 may be disposed therein. The second driving part 150 may be rotatably disposed in the third accommodating part 135 according to an embodiment of the present disclosure.

Referring to FIG. 2, the third accommodating guide groove 135gh may be formed in a groove shape at one side of the third accommodating part 135 according to an embodiment of the present disclosure, and the third accommodating guide groove 135gh may be formed to communicate with the second accommodating guide groove 133gh formed in the second accommodating part 133.

Referring to FIG. 2, since the third accommodating guide groove 135gh according to an embodiment of the present disclosure is formed in a groove shape, the guide part 132 formed in the first accommodating part 131 may pass through the second accommodating guide groove 133gh and the third accommodating guide groove 135gh, the third accommodating part 135 and the second accommodating part 133 may be sequentially stacked and disposed on the first accommodating part 131, and a coupling path between the first accommodating part 131, the second accommodating part 133, and the third accommodating part 135 may be provided.

Referring to FIG. 2, a groove (not denoted by reference numeral) having a curved shape may be formed in the third accommodating part 135 according to an embodiment of the present disclosure, and the second driving part 150 to be described below, specifically, a driving control part 153 formed to protrude from the second driving body 151, may be seated therein.

The driving control part 153 according to an embodiment of the present disclosure may rotate clockwise or counterclockwise inside the groove along a rotational central axis AX.

A plurality of driving control parts 153 to be formed in the second driving part 150 may be provided and may be formed to protrude from opposite sides thereof, and a plurality of grooves in which the driving control parts 153 may be seated may be provided to correspond to the plurality of driving control parts 153.

Referring to FIG. 2, a hole (not denoted by reference numeral) communicating with the hole formed in the first accommodating part 131 may be formed in the third accommodating part 135 according to an embodiment of the present disclosure, and a support bar 136 connecting a preset region may be formed to extend from the hole.

Referring to FIG. 2, the support bar 136 according to an embodiment of the present disclosure may be in contact with and support a lower surface (based on FIG. 4) of the second driving part 150 to be described below. Specifically, the support bar 136 may be in surface contact with the lower surface of the second driving part 150.

Referring to FIGS. 2 and 4, due to the support bar 136 being formed in the third accommodating part 135 according to an embodiment of the present disclosure, when the second driving part 150 is rotated using a longitudinal central axis of the driving control part 153 as a rotational central axis, it is possible to limit a rotation radius of the second driving part 150.

That is, since the lower surface (based on FIG. 4) of the second driving part 150 is hung on the support bar 136, it is possible to prevent the second driving part 150 from passing through a corresponding position to be rotated toward the first driving part 140 accommodated in the first accommodating part 131 and it is possible to stably support a position of the second driving part 150.

Referring to FIGS. 1, 2, and 4 to 7, the first driving part 140 according to an embodiment of the present disclosure may be accommodated in the base part 130 and may include a first magnetic force part 145.

The first magnetic force part 145 according to an embodiment of the present disclosure may contain a magnetic material and may be formed of a permanent magnet, specifically, a magnet having a low coercive force (for example, an alnico magnet or the like).

Referring to FIGS. 1 and 4, the first driving part 140 according to an embodiment of the present disclosure may be accommodated in the base part 130, specifically, the first accommodating part 131, and may be disposed adjacent to the driving source part 110 accommodated in the first accommodating part 131.

Specifically, the first driving part 140 may be disposed inside the driving source part 110. The first driving part 140 may share a longitudinal central axis with the driving source part 110.

The first magnetic force part 145 according to an embodiment of the present disclosure may have a relatively greater magnetic force than a second magnetic force part 155 provided in the second driving part 150.

As a result, an external force applied by a user may be applied to the expression part 120, and in a situation in which the second driving part 150 may not rotate, after the external force applied to the expression part 120 is removed, the second magnetic force part 155 and the second driving part 150 in which the second magnetic force part 155 is disposed may be rotated by a magnetic force of the first magnetic force part 145 to move the expression part 120 in the first direction and a direction opposite to the first direction.

That is, even when a driving force cannot be transmitted to the second driving part 150 through the driving source part 110 and the first driving part 140 due to an external force applied to the expression part 120, as power is provided only for a relatively short time, the first driving part 140 may be disposed to have polarity in a preset direction by a current applied to the driving source part 110, and when the external force applied to the expression part 120 is removed, the second driving part 150 may perform angular movement or rotational movement by polarity of the first magnetic force part 145 provided in the first driving part 140.

The first magnetic force part 145 according to an embodiment of the present disclosure may have a first magnetic region 145a (N pole or S pole) and a second magnetic region 145b (S pole or N pole) having different polarities, and the first magnetic region 145a and the second magnetic region 145b having different polarities may be arranged at one point of the first magnetic force part 145 in a direction from the driving source part 110 toward the expression part 120, for example, in the vertical direction (based on FIG. 1).

Referring to FIG. 4, in a state in which a position of the first magnetic force part 145 according to an embodiment of the present disclosure is fixed inside the driving source part 110, the first magnetic region 145a and the second magnetic region 145b may be formed (based on FIG. 4) in the vertical direction, and when a current is applied to the driving source part 110, polarities of the first magnetic region 145a and the second magnetic region 145b formed in the first magnetic force part 145 may be changed.

In the information output device 100 according to an embodiment of the present disclosure, the driving source part 110 surrounds the first magnetic force part 145 and polarity of the first magnetic force part 145 is changed when a current is applied to the driving source part 110, but the present disclosure is not limited thereto, and various modifications may be implemented without departing from the technical spirit in such a manner that a current is directly or indirectly applied to the first magnetic force part 145 and the polarities of the first magnetic region 145a and the second magnetic region 145b may be changed.

Since the polarities of the first magnetic region 145a and the second magnetic region 145b positioned in the first magnetic force part 145 are formed, the driving force may be transmitted to the second driving part 150, and specifically, an attractive force or a repulsive force may be generated for the second magnetic force part 155 provided in the second driving part 150.

That is, when a current is applied to the driving source part 110, polarity may be formed in the first driving part 140, specifically, the first magnetic force part 145, and according to the polarity formed in the first magnetic region 145a positioned relatively close to the second driving part 150, the second magnetic force part 155 provided in the second driving part 150 may be pushed or pulled.

By an interaction between the first magnetic force part 145 provided in the first driving part 140 and the second magnetic force part 155 provided in the second driving part 150 according to an embodiment of the present disclosure, the second driving part 150 may perform angular movement or rotational movement and may transmit a driving force to the expression part 120.

Referring to FIGS. 1 to 4, the second driving part 150 according to an embodiment of the present disclosure may be disposed between the first driving part 140 and the expression part 120 and may be rotatably disposed in the base part 130.

The second driving part 150 may perform angular movement or rotational movement according to the driving of the first driving part 140 and may transmit a driving force to the expression part 120.

Referring to FIGS. 4 to 7, the second driving part 150 according to an embodiment of the present disclosure may maintain a state of being in contact with the expression part 120.

As a result, when the second driving part 150 receives a driving force from the first driving part 140 and performs angular movement or rotational movement, the expression part 120 in contact with the second driving part 150 may be moved in the first direction away from the driving source part 110 or the first driving part 140 (from the lower side to the upper side based on FIG. 4) or a direction (from the upper side to the lower side based on FIG. 4) opposite to the first direction.

Referring to FIG. 4, the second driving part 150 according to an embodiment of the present disclosure may be disposed to be spaced apart from the first driving part 140 by a preset interval.

Referring to FIGS. 1, 3, and 4, the second driving part 150 according to an embodiment of the present disclosure may include the second driving body 151 and the second magnetic force part 155.

Referring to FIGS. 1 to 4, the second driving body 151 accommodates the second magnetic force part 155, and may be accommodated in the base part 130, specifically, the third accommodating part 135.

Referring to FIGS. 1 and 4 to 7, the second driving body 151 according to an embodiment of the present disclosure may be rotatably disposed in the third accommodating part 135. An accommodation space capable of accommodating the second magnetic force part 155 may be formed inside the second driving body 151.

Referring to FIGS. 3 and 4, the second driving body 151 according to an embodiment of the present disclosure may have a plurality of surfaces in a circumferential direction of the rotational central axis AX, and a driving surface 151a, a base surface 151b, and a connection surface 151c may be formed along a circumference of the rotational central axis AX.

Referring to FIGS. 3 and 4, the driving surface 151a may be a surface in contact with the expression part 120 and may maintain a state of being in contact with the expression part 120.

In a circumferential direction with respect to the rotational central axis AX of the second driving body 151, one side of the driving surface 151a may be connected to the base surface 151b, and another side opposite to the one side may be connected to the connection surface 151c.

Referring to FIGS. 3 and 4, a curved part 152 may be formed in a section in which the driving surface 151a and the base surface 151b are connected. The curved part 152 may have a certain radius of curvature. The curved part 152 may be formed to be convex outward.

In an optional embodiment, the curved part 152 may include a boundary line similar to that of a circle.

The curved part 152 formed in a preset region of the driving surface 151a may be formed at another side (right side based on FIG. 4) opposite to one side (left side based on FIG. 4) of the second driving body 151 form which the driving control part 153 is formed to protrude.

Since the curved part 152 is formed in a region in which the driving surface 151a and the base surface 151b are connected, when the second driving body 151 receives a driving force from the first driving part 140 and performs angular movement or rotational movement, the expression part 120 may move smoothly along the curved part 152 formed on the driving surface 151a and to efficiently perform continuous and natural movement.

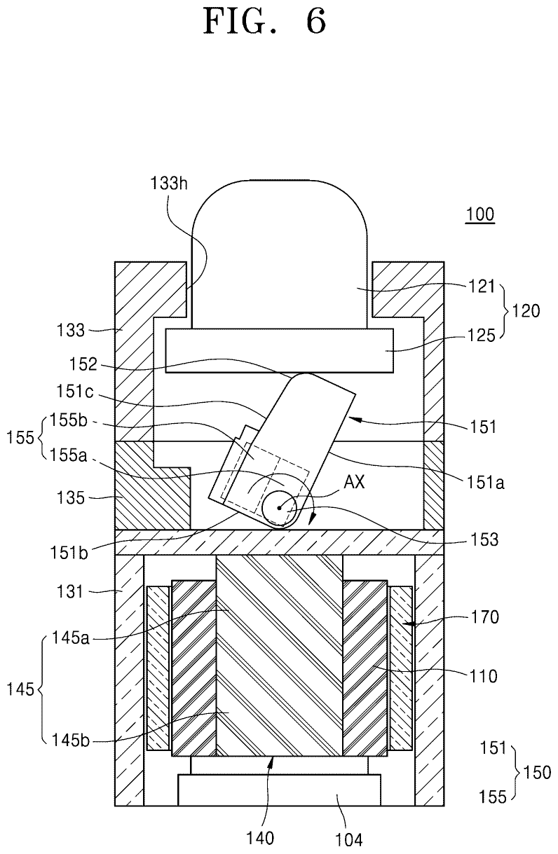

In addition, when the expression part 120 moves in the first direction (from the lower side to the upper side based on FIG. 4) away from the driving source part 110 and then moves in an opposite direction (from the upper side to the lower side based on FIG. 6), the expression part 120 may move smoothly while maintaining a state of being in contact with the second driving body 151.

Referring to FIGS. 3 and 4, the base surface 151b formed in the second driving body 151 may be in contact with the base part 130, specifically, the third accommodating part 135, and in the circumferential direction with respect to the rotational central axis AX of the second driving body 151, one side (left side based on FIG. 4) of the base surface 151b may be connected to the connection surface 151c, and another side (right side based on FIG. 4) thereof may be connected to the driving surface 151a.

The base surface 151b may be formed to be flat and may be disposed on the third accommodating part 135 in a state of being in surface contact with the support bar 136 formed on the third accommodating part 135. Thus, an initial position (the position in FIG. 4) of the second driving body 151 may be maintained, and the second driving body 151 may be stably supported on the third accommodating part 135.

Referring to FIGS. 3 and 4, the connection surface 151c formed in the second driving body 151 may be a surface that connects the base surface 151b to the driving surface 151a and may be formed to be flat. A section in which the connection surface 151c and the base surface 151b are connected may have a certain radius of curvature and may be formed in a curved shape.

Thus, the second driving body 151 may stably rotate on the third accommodating part 135 when rotating around the longitudinal central axis of the driving control part 153 to be described below as the rotational central axis AX.

Referring to FIGS. 3 and 4, except for the section in which the connection surface 151c and the base surface 151b are connected, regions formed to be flat may be disposed to form a certain angle. Thus, it is possible to limit a rotation range of the second driving body 151 with respect to the rotational central axis AX.

That is, a virtual straight line passing through a flat region in the connection surface 151c and a virtual straight line passing through a flat region in the base surface 151b may be disposed to form a certain angle.

According to an embodiment of the present disclosure, surfaces respectively formed to be flat in the connection surface 151c and the base surface 151b may be perpendicular to each other, and a rotation range of the second driving body 151 may be set to 90 degrees.

However, the present disclosure is not limited thereto, and the angle formed by the surfaces respectively formed to be flat in the connection surface 151c and the base surface 151b may be variously formed according to the rotation range of the second driving body 151.

Referring to FIG. 5, since the connection surface 151c is formed to be flat, when the second driving body 151 rotates, the connection surface 151c may be in surface contact with the support bar 136 formed in the third accommodating part 135 and may stably maintain a position.

Referring to FIGS. 3 to 7, the driving control parts 153 may be formed to protrude outward from opposite side surfaces of the second driving body 151 according to an embodiment of the present disclosure. The driving control part 153 may extend along a longitudinal central axis, and the longitudinal central axis of the driving control part 153 may be formed as the rotational central axis AX of the second driving body 151.

Referring to FIGS. 3 to 7, the driving control part 153 according to an embodiment of the present disclosure may be formed at a point spaced a certain distance apart from a center on a side surface of the second driving body 151 from which the driving control part 153 is formed to protrude.

In the present specification, the side surface of the second driving body 151 refers to one surface of the second driving body 151 viewed from the front in FIGS. 4 to 7.

That is, referring to FIG. 4, the driving control part 153 may be positioned to be biased to one side (left side based on FIG. 4) with respect to the center of the second driving body 151 and may be positioned on a longitudinal central axis of the first driving part 140.

With respect to the center of the second driving body 151, the curved part 152 according to an embodiment of the present disclosure may be formed at another side (right side based on FIG. 4) opposite to one side (left side based on FIG. 4) at which the driving control part 153 is positioned, and thus, when the second driving body 151 rotates using the longitudinal central axis AX of the driving control part 153 as a rotational central axis, a torque force may be easily generated, and the second driving part 150 may be allowed to perform angular movement or rotational movement, thereby allowing the expression part 120 to efficiently move and improving the precise expression power of the information output device 100.

In addition, since a torque force for the second driving part 150 is easily generated, power consumption of the information output device 100 may be reduced.

Referring to FIGS. 4 to 7, the driving control parts 153 formed on opposite side surfaces of the second driving body 151 may be seated in grooves formed in the third accommodating part 135 and may be rotated clockwise or counterclockwise in the grooves.

That is, the second driving part 150 according to an embodiment of the present disclosure may rotate clockwise or counterclockwise using the driving control parts 153 as a rotational center.

Referring to FIGS. 1 to 7, the second magnetic force part 155 according to an embodiment of the present disclosure may be disposed inside the second driving body 151 and may have regions having different polarities.

The second magnetic force part 155 according to an embodiment of the present disclosure may contain a magnetic material and may include, for example, a permanent magnet. The second magnetic force part 155 may have a relatively smaller magnetic force than the first magnetic force part 145.

As a result, a region formed in the second magnetic force part 155 may be changed by the first magnetic force part 145, and the second driving part 150 in which the second magnetic force part 155 is accommodated may be moved, but, due to a magnetic force of the second magnetic force part 155, a magnetic region formed in the first magnetic force part 145 may be prevented from being changed.

In other words, an external force applied by a user may be applied to the expression part 120, and in a situation in which the second driving part 150 may not rotate, after the external force applied to the expression part 120 is removed, the second magnetic force part 155 and the second driving part 150 in which the second magnetic force part 155 is disposed may be rotated by a magnetic force of the first magnetic force part 145 to move the expression part 120 in the first direction and a direction opposite to the first direction.

That is, even when a driving force cannot be transmitted to the second driving part 150 through the first driving part 140 due to an external force applied to the expression part 120, as power is provided only for a relatively short time, polarity of the first driving part 140, specifically, polarity of the first magnetic force part 145, may be formed in a preset direction by the driving force transmitted from the driving source part 110, and when the external force applied to the expression part 120 is removed, the second driving part 150 may perform angular movement or rotational movement by the first driving part 140.

Referring to FIGS. 4 to 7, the second magnetic force part 155 according to an embodiment of the present disclosure is disposed to be spaced apart from the curved part 152 formed in the second driving body 151, and the second driving body 151 may be disposed relatively close to the rotational central axis AX.

That is, the second magnetic force part 155 may be disposed to overlap the driving control part 153 formed to protrude from the second driving body 151. As a result, when a current is applied to the driving source part 110 and polarity of the first driving part 140, specifically, polarity of the first magnetic force part 145, is formed, an attractive force or a repulsive force between the first magnetic force part 145 and the second magnetic force part 155 is generated, and in this case, the curved part 152 spaced apart from the rotational central axis may be rotated clockwise or counterclockwise, and a torque force for the second driving part 150 may be easily generate.

Referring to FIG. 4, the longitudinal central axis of the driving control part 153 formed in the second driving body 151 may be perpendicular to a longitudinal central axis of the first magnetic force part 145.

Referring to FIGS. 4 to 7, the second magnetic force part 155 according to an embodiment of the present disclosure may have a first magnetic region 155a (N pole or S pole) and a second magnetic region 155b (S pole or N pole) which have different polarities, and the first magnetic region 155a and the second magnetic region 155b having different polarities may be disposed in a height direction (the vertical direction based on FIG. 4) of the second driving body 151.

Referring to FIGS. 4 to 7, by the attractive force or the repulsive force generated between the second magnetic force part 155 and the first magnetic force part 145 according to an embodiment of the present disclosure, the second driving body 151 may rotate clockwise or counterclockwise using the longitudinal central axis AX of the driving control part 153 as a rotational central axis to move the expression part 120 in the vertical direction (based on FIG. 4).

Referring to FIGS. 1, 2, and 4, the shielding part 170 according to an embodiment of the present disclosure may be accommodated in the base part 130, specifically, the first accommodating part 131, and may be formed to be hollow.

The shielding part 170 according to an embodiment of the present disclosure may be disposed between the first accommodating part 131 and the driving source part 110 and may be formed of a high permeability material. The shielding part 170 may be formed in a shape surrounding the driving source part 110 and may block a magnetic field, which is generated when a current is applied to the driving source part 110, from being transmitted to the outside.

In addition, the single information output device 100 including the driving source part 110, the first driving part 140, the second driving part 150, and the expression part 120 and another information output unit disposed adjacent to the single information output device 100 are allowed to remain unaffected by a magnetic field so that a plurality of information output units may be independently driven.

The shielding part 170 according to an embodiment of the present disclosure may be formed in a cylindrical shape, but the present disclosure is not limited thereto, and various modifications may be implemented.

The operating principle and effect of the information output device 100 according to an embodiment of the present disclosure as described above will be described.

Referring to FIGS. 1 to 7, the information output device 100 according to an embodiment of the present disclosure may include the substrate part 101, the driving source part 110, the expression part 120, the base part 130, the first driving part 140, the second driving part 150, and the shielding part 170.

Referring to FIGS. 1 and 4 to 7, the driving source part 110 according to an embodiment of the present disclosure may be formed of a coil, and a magnetic field may be formed when a current is received from an external power supply through the substrate part 101.

Different polarities may be formed in the first driving part 140, specifically, the first magnetic force part 145 by the magnetic field formed in the driving source part 110.

Referring to FIG. 4, the first magnetic region 145a formed in the first magnetic force part 145 when the driving source part 110 receives a current may be formed as an S pole, and the second magnetic region 145b formed in the first magnetic force part 145 to be closer to the substrate part 101 than the first magnetic region 145a may be formed as an N pole.

Referring to FIG. 4, the first magnetic region 155a formed in the second magnetic force part 155 accommodated inside the second driving body 151 may be formed as an S pole, and the second magnetic region 155b formed in the second magnetic force part 155 to be closer to the expression part 120 than the first magnetic region 155a may be formed as an N pole.

In a polarity arrangement of the second magnetic force part 155, the first magnetic region 155a is formed as an S pole and the second magnetic region 155b is formed as an N pole, and thus, a repulsive force is formed between the second magnetic force part 155 and first magnetic force part 145.

Referring to FIGS. 4 and 5, since the repulsive force is generated between the first magnetic force part 145 and the second magnetic force part 155, the second driving body 151 may rotate counterclockwise (based on FIG. 5) using the driving control part 153 as the rotational central axis AX.

That is, the first magnetic region 155a formed in the second magnetic force part 155 tends to move to a position away from the driving source part 110, and the second magnetic region 155b moves to a position toward the driving source part 110 by an attractive force.

Since the driving control part 153 is disposed on the longitudinal central axis of the first magnetic force part 145, and the curved part 152, which is formed in a region in which the driving surface 151a and the base surface 151b are connected in the driving body part, is spaced apart from the longitudinal central axis of the driving control part 153 and the first magnetic force part 145, a torque force may be easily generated.

In addition, by allowing the second driving part 150 to perform angular movement or rotational movement, the movement of the expression part 120 may be efficiently performed, and the precise expression power of the information output device 100 may be improved.

In addition, since a torque force for the second driving part 150 is easily generated, power consumption of the information output device 100 may be reduced.

As the second driving part 150 rotates, the expression part 120 also moves along the curved part 152 in a direction (from the lower side to the upper side based on FIG. 5) away from the driving source part 110 and the first driving part 140.

Referring to FIG. 5, since the connection surface 151c connected to each of the driving surface 151a and the base surface 151b is formed to be flat, and a virtual straight line passing through the connection surface 151c is disposed to be perpendicular to a virtual straight line passing through the base surface 151b, the second driving part 150 being rotated at a preset angle or more may be controlled.

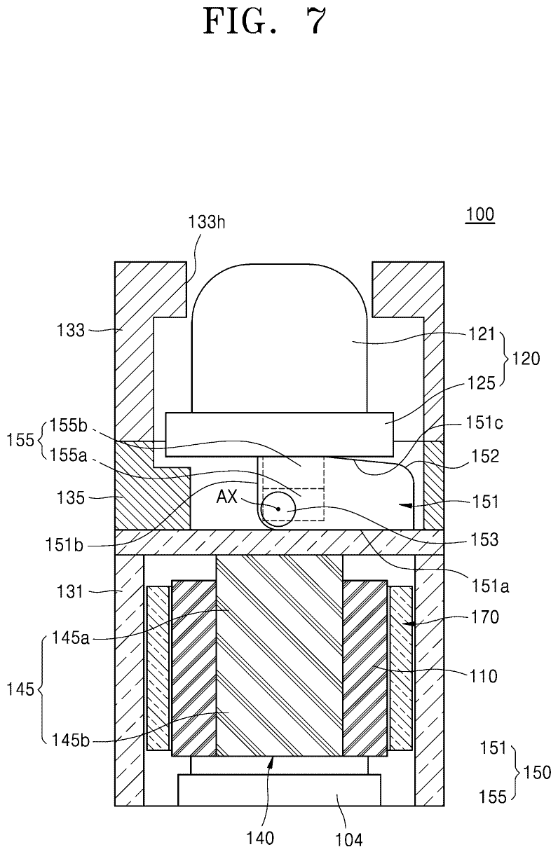

Referring to FIGS. 6 and 7, a state in which power applied to the driving source part 110 is cut off is shown, and unlike that shown in FIG. 4, the first magnetic region 145a formed in the first magnetic force part 145 may be formed as an N pole, and the second magnetic region 145b formed in the first magnetic force part 145 to be relatively closer to the substrate part 101 than the first magnetic region 145a may be formed as an S pole.

Thus, the first magnetic region 155a of the second magnetic force part 155 disposed relatively close to the first magnetic force part 145 moves toward the driving source part 110 by an attractive force, and the second magnetic region 155b of the second magnetic force part 155 moves in a direction away from the driving source part 110 by a repulsive force.

In other words, the second driving body 151 rotates clockwise using the longitudinal central axis of the driving control part 153 as the rotational central axis AX.

As a result, the second driving body 151, specifically, the expression part 120 maintaining a state of being in contact with the driving surface 151a may move toward the driving source part 110 (from the upper side to the lower side based on FIG. 6).

In the information output device 100 according to an embodiment of the present disclosure, the driving source part 110 may surround the first driving part 140, and as a current is applied to the driving source part 110, the polarity of the first magnetic force part 145 may be changed, and a driving force may be transmitted to the second driving part 150 due to an interaction with the second magnetic force part 155 provided in the second driving part 150.

In addition, since the polarity of the first magnetic force part 145 may be changed by a current applied to the driving source part 110 in a state in which a position of the first driving part 140 is maintained, a separate power transmission structure may not be required and the structure to simplify a structure.

In addition, the curved part 152 is formed in a region in which the driving surface 151a and the base surface 151b formed in the second driving body 151 are connected, in a process of moving the expression part 120, the expression part 120 may maintain a state of being in contact with the second driving body 151, may move smoothly, and may effectively perform continuous and natural movement.

The particular implementations shown and described herein are illustrative embodiments and are not intended to otherwise limit the scope of the present disclosure in any way. In addition, the connecting lines, or connection members shown in the drawings presented are intended to represent exemplary functional relationships and/or physical or logical couplings between the components. It should be noted that many alternative or additional functional relationships, physical connections, or logical connections may be present in a practical device. Further, no item or component is essential to the practice of the present disclosure unless the components are specifically described as “essential” or “critical”.

Therefore, it should be noted that the spirit of the present disclosure is not limited to the embodiments described above, and not only the claims to be described below, but also all ranges equivalent to or equivalently changed from the claims fall within the scope of the spirit of the present disclosure.

### INDUSTRIAL APPLICABILITY

According to the present disclosure, an information output device is provided. In addition, embodiments of the present disclosure may be applied to a device that allows a user to recognize information using industrially used tactile senses.

1. An information output device comprising one or more information output units,
wherein each of the one or more information output units includes:
a driving source part connected to a power supply and disposed to allow a current to flow;
an expression part formed and disposed to be detected by a user;
a base part in which the driving source part and the expression part are accommodated;
a first driving part disposed in the base part and driven by the current flowing in the driving source part; and
a second driving part disposed between the first driving part and the expression part, rotatably disposed in the base part, configured to perform an angular movement or a rotational movement in response to the driving of the first driving part to transmit a driving force to the expression part.

2. The information output device of claim 1, wherein the base part includes:
a first accommodating part in which the driving source part is accommodated;
a second accommodating part which is disposed to face the first accommodating part and in which the expression part is accommodated; and
a third accommodating part which connects the first accommodating part to the second accommodating part and in which the second driving part is disposed.

3. The information output device of claim 1, wherein the first driving part includes a first magnetic force part and is disposed inside the driving source part.

4. The information output device of claim 3, wherein the first driving part shares a longitudinal central axis with the driving source part.

5. The information output device of claim 1, comprising a plurality of information output units,
wherein the plurality of information output units are disposed to be spaced apart from each other in one direction or another direction different from the one direction.
